(19) United States
(12) Patent Application Publication
(10) Pub. No.: US 2005/0072770 A1
(43) Pub. Date: Apr. 7, 2005

(54) Domestic electric oven

(76) Inventors: Michel Klinger, Stosswihr (FR); Alain Didier-Laurent, Vagney (FR); Dominique Antoine, Cleurie (FR)

Correspondence Address: BROWDY AND NEIMARK, P.L.L.C.;624 NINTH STREET, NW, SUITE 300, WASHINGTON, DC, 20001-5303, US

(21) Appl. No.: 10/503,077

(22) PCT Filed: Jan. 29, 2003
(86) PCT No.: PCT/FR03/00272

(30) Foreign Application Priority Data
Jan. 30, 2002 (FR) 02/01101

(51) Int. Cl. A21B 1/00; A21B 1/22; F27D 11/00

(52) U.S. Cl. 219/405

(57) ABSTRACT

The present invention relates to a domestic electric cooking oven (1) comprising an enclosure (2) defined by two side faces (4a, 4b), a top face (4c), a bottom face (4e), and a rear face (4d), main heater means of the radiant type that emit essentially in the infrared arranged inside the enclosure (2), said oven (1) including a cabinet (16) surrounding the major portion of the enclosure (2) over the side faces (4a, 4b) and the top face (4c), the front face of the oven being fitted with a door and with a control panel, the oven (1) being characterized in that it includes means for limiting heating of the oven cabinet (16), selected from the following:
confinement by partitioning the space between the top (4c) of the enclosure (2) and the top portion (18c) of the cabinet (16);
a reflector (20);
no ventilation openings in the cabinet (16); and
a metal face plate (28) disposed substantially over the door, and connected to the cabinet (16) by an insulating rod (30).

The present invention relates to electric cooking appliances of the oven type containing a cooking enclosure with radiant type heater means arranged therein, radiating essentially in the infrared. The present invention relates in particular to ovens suitable for being placed on a work surface, as contrasted with ovens suitable for being incorporated in a “fitted” kitchen.

Ovens standing on legs are ovens having a very wide variety of capacities, lying in a range from about 10 liters (l) to nearly 40 l, but in general they all present cooking temperatures capable of reaching 250° C. inside the cooking enclosure. The present invention relates to ovens having means for heating the air inside the enclosure together with the food therein by using heater elements that radiate in the infrared, possibly in association with means for circulating the air. The wall temperature of such ovens therefore rises, as contrasted with microwave ovens, in particular.

This temperature constraint frequently leads to the cooking enclosure being covered by a metal cabinet made of sheet steel suitable for being painted or enameled on the outside, and constituting an outer casing for the oven. The sheet steel heats up in turn and constitutes a hazard which might burn the user.

Efforts have already been made to protect the user from burning when handling the door of the oven. Document FR 2 732 097 describes in particular a cooking oven door comprising a frame having an inner glass wall and an outer plastics wall mounted thereon, which door includes means for ventilating between the two walls in order to reduce the temperature of the outer wall.

However, for ovens that are placed on a work surface, the door is not the only potential source of burns. The same applies to the outside walls of the oven, which are easily accessible to the user or to other people, in particular children.

The present invention seeks to use means that are simple and inexpensive to reduce the risk of being burnt on touching the outside parts of a domestic electric oven operating by radiation and by convection.

The present invention is achieved by means of a domestic electric cooking oven comprising an enclosure defined by two side faces, a top face, a bottom face, and a rear face, main heater means of the radiant type that emit essentially in the infrared arranged in the enclosure, said oven having a cabinet surrounding the major part of the enclosure over its side faces and its top face, the front face of the oven being fitted with a door and a control panel, the oven being characterized in that it includes means limiting the heating of the oven cabinet.

By considerably reducing the temperature of the outside walls of the oven in this way, users and people with them are protected from being burnt on touching the walls of the oven.

Furthermore, by reducing the temperature of the oven cabinet, it is possible to make use of a material that does not withstand high temperatures, such materials generally being of low cost.

Advantageously, the cabinet also covers the major part of the rear face of the cooking enclosure. Although the rear face of the oven is less accessible than the side faces and the top face, it is advantageous for the cabinet also to cover a significant fraction of the rear face of the enclosure so as to minimize the risk of burns.

In the invention, the means limiting heating of the cabinet of the oven comprise confinement by partitioning the space between the top of the enclosure from the top portion of the cabinet.

The term “confinement” should thus be understood and interpreted as holding captive or in isolation the volume of air that is situated between the top of the enclosure and the top of the cabinet.

This confinement may be obtained in various ways, in particular by providing no ventilation openings in the cabinet, in particular in its top wall, or in the portions of the side walls situated level with and above the top of the enclosure, thereby minimizing air circulation.

Air circulating in the volume situated between the top of the enclosure and the top of the cabinet leads to the temperature of the top of the cabinet increasing because of the resulting stirring of the air. Furthermore, hot points are then generated at the openings in the cabinet, locally increasing its temperature, and possibly leading to deterioration of the material used for making the cabinet.

Nevertheless, this closure of the space is not leaktight, but should be understood qualitatively as minimizing air exchange with the outside. Thus, residual openings for construction purposes do not contribute significantly to exchanging heat with the outside.

In addition, such an arrangement prevents foreign bodies being inserted which could lead to problems of hygiene and/or to thermal bridges between the enclosure and the cabinet.

An improvement to this confinement of the space above the top of the enclosure consists in providing a peripheral rim on the face of the top of the enclosure.

Advantageously, a heat screen is disposed in the confinement space between the top portion of the cabinet and the top of the enclosure, thereby further reducing the temperature of the top of the cabinet. In order to reinforce its effect, the heat screen covers at least the entire surface of the top of the enclosure.

Advantageously, the heat screen has vertical walls sloping downwards and extending over the side faces and the rear face as far as the cabinet of the oven, thus establishing dual partitioning of the air, firstly between the top of the enclosure and the heat screen, and secondly between the heat screen and the oven cabinet.

Extending the heat screen along the vertical rear and side faces of the cabinet thus enables said walls to be further protected against excessive heating, thus reducing their temperature. The risks of burns are thus reduced.

In an embodiment of the invention, a spacer of material having low thermal conductivity (e.g. less than 1 watt per meter per kelvin (Wm⁻¹K⁻¹)) is placed substantially in the middle of the heat screen extending on either side of said screen, perpendicularly thereto, both to the cabinet and to the vicinity of the top of the enclosure.

The spacer thus serves to maintain some minimum distance between the top of the enclosure and the heat screen, and also between the top of the cabinet and said heat screen.

When the oven enclosure is of large size, the spacer also makes it possible to provide mechanical reinforcement and avoid sagging, e.g. due to a heavy object being placed on top of the oven cabinet.

Advantageously, a metal face plate is disposed substantially over the door, at least over the length of the cooking enclosure, said face plate being connected to the cabinet by an insulating rod.

Placing a metal face plate over the oven door serves to absorb locally the heat rising from the oven via the door, thus constituting overall a thermal retarder on the temperature rise of the cabinet.

Although it is possible to make a cabinet which presents the above-specified characteristics vertically above the door, e.g. by increasing the number of heat screens, a simple solution can consist in locally replacing the cabinet to a shallow depth by means of a metal wall which serves to dissipate heat, acting as a safety valve since the heat will preferentially be exchanged with the outside by means of this face plate, which will occur without air being stirred. This aspect is particularly important when cooking is performed with the door open, thereby generating a large upward flow of heat above the door.

Advantageously, the metal face plate includes fine openings to encourage heat exchange between the inside of the enclosure and the outside, thereby increasing the thermal retarder effect. These fine openings at the top and the front of the oven should nevertheless be sufficiently fine and offset to avoid leading to significant stirring of air or air circulation.

The insulating rod performs a local thermal retarder function between the metal zone and the cabinet. Advantageously, the rod is made of temperature-resistant plastics material such as poly(1,4-butanediol terephthalate), more commonly known as PBT.

The “temperature resistant” is used to mean a material that retains good mechanical properties when its temperature rises, and that does so over a large temperature range. Such materials are commonly referred to as engineering plastics. From this point of view, one of the advantages of using PBT is that it retains a high Young's modulus up to temperatures close to its melting temperature. In addition, PBT is very rigid.

The temperature-resistant aspect of plastics materials can be qualified in terms of various properties. Mention can be made of sagging temperature as specified in the NF T 51-005 standard, of the hot ball pressure test temperature as specified in the NF C 62-411 standard, or indeed of the Vicat B softening temperature as specified in the standard NF T 51-021. It is therefore preferable to use materials that present properties of high grade in terms of the standards mentioned.

In a preferred embodiment of the invention, the oven cabinet is made of a thermoplastic type of material.

By using a thermoplastic type material, such as polypropylene (PP) for example, the cost of such a cabinet is reduced considerably, while nevertheless providing greater flexibility in terms of providing shapes and colors.

Furthermore, the use of a plastics material also provides the advantage of presenting a contact temperature between the skin and said material that is lower than would be the case with a conventional cabinet made of enameled or plated sheet metal, and with the cabinet at the same temperature. This is due to the difference between the effusivities of PP and of metals such as steel.

Thus, for a given cabinet temperature, contact between the cabinet and the skin will take place at a lower temperature if the cabinet is made of PP rather than being made of enameled or plated steel sheet, for example.

In addition, plastics lends themselves to molding operations that are easily automated and permit greater freedom in the design aspects of the product.

The present invention will be better understood on reading the following description given with reference to the accompanying figures, in which:

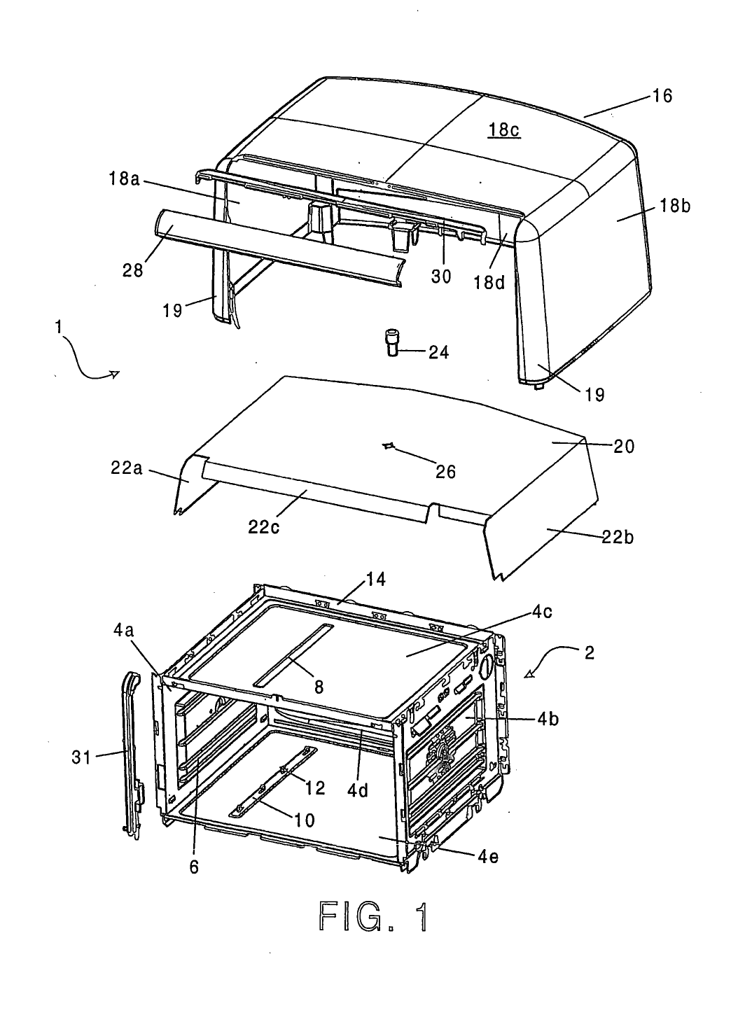

FIG. 1 is an exploded perspective view of the various elements making up the oven of the invention;

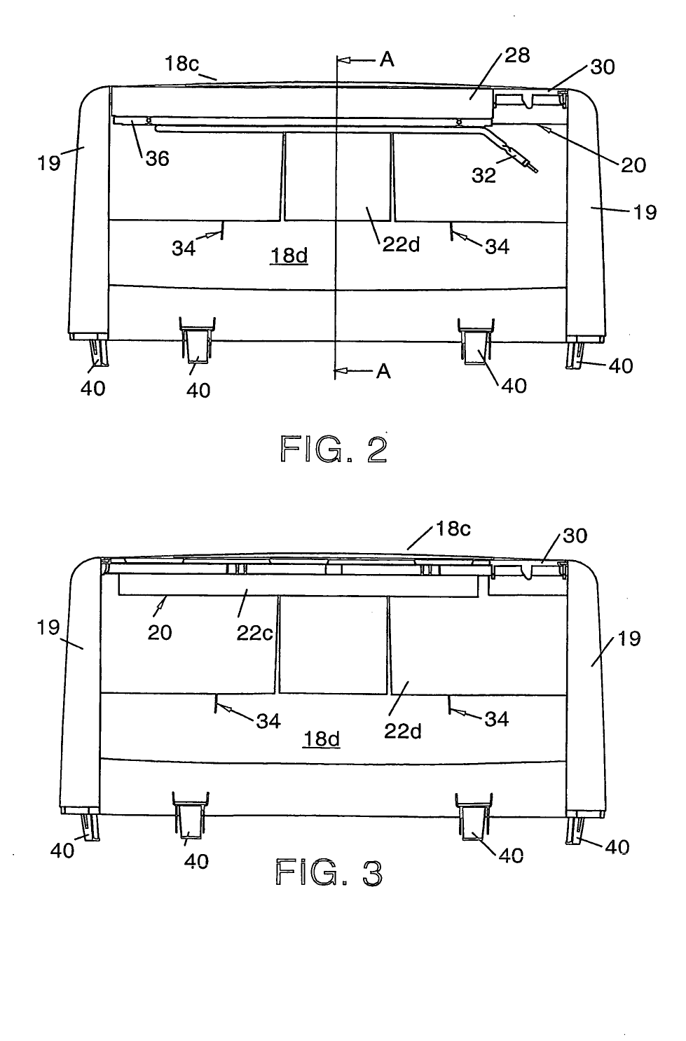

FIGS. 2 and 3 are fragmentary views of the front face of the oven;

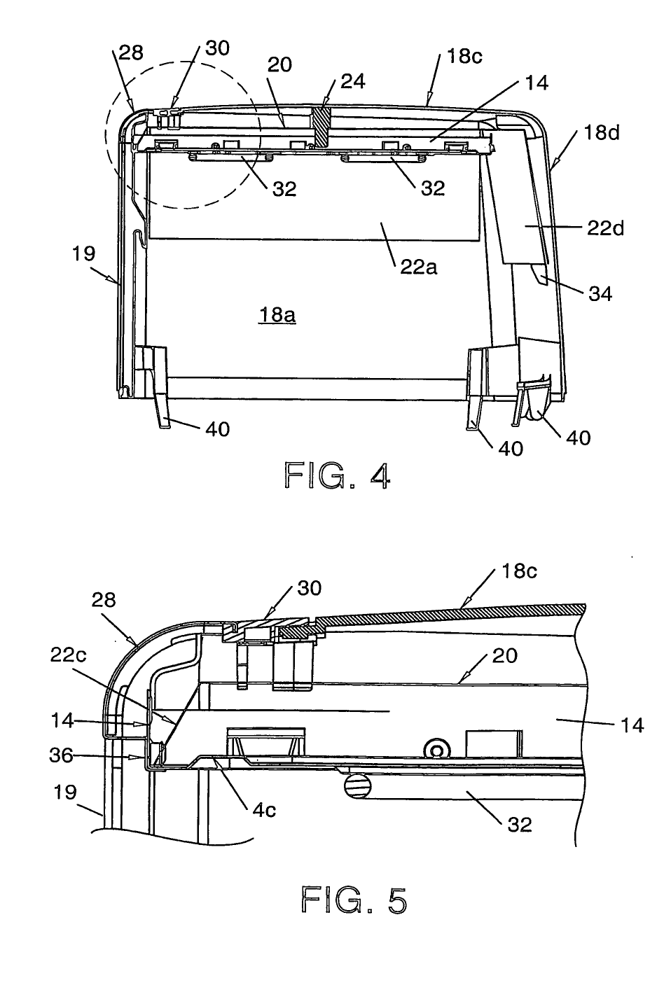

FIG. 4 is a view on section A-A of FIG. 2; and

FIG. 5 is a view on a larger scale of the portion of FIG. 2 marked by a circle.

With reference in particular to FIG. 1, the oven 1 of the present invention comprises in known manner a cooking enclosure 2 made up of five metal sheets defining faces 4a to 4e, which sheets are assembled together to form a volume in the form of a rectangular parallelepiped that is open in front. A door (not shown) is placed over said opening to close the volume of the enclosure.

The side faces 4a and 4b include channels 6 for holding a cooking grid. The control portion of the oven (not shown) is faced adjacent to the face 4b, outside the enclosure.

The horizontal faces constituting the top 4c and the bottom 4e of the enclosure include respective stamped projections 8 and 10 serving to hold heater. resistance elements 32, as visible in FIGS. 2, 4, and 5, spaced apart from the surfaces of said faces. The bottom projections 10 also have element-fastening hooks 12. The top face 4c is surrounded by a peripheral rim 14 obtained either by folding said top face or by extending the side faces.

This enclosure is placed on a stand (not shown), which may be made of metal or of an engineering plastics material of the PBT type that can withstand high temperatures, as explained above. In a less expensive variant, the stand may be made of PP including supports made of PBT.

According to a characteristic of the invention, the oven has a cabinet 16 for housing the enclosure, which cabinet is made up of four walls 18a to 18d. One of the special features of this cabinet is that it covers the faces of the cooking enclosure other than the horizontal bottom face 4e. This cabinet is also free of openings or slots of the kinds commonly encountered in commercially-available ovens. In particular, the face 18c forming the top of the cabinet co-operates with the rim 14 and the top margins of the vertical faces to provide partitioning which confines the space situated above the top 4c of the enclosure. By thus preventing cold air penetrating from the outside, the circulation of hot air in contact with the top of the enclosure is restricted, which circulation would otherwise lead to the temperature of the cabinet being increased.

The walls 18a and 18b present respective flanges 19 extending towards the front face of the oven, serving to mask the internal edges of the metal structure while also giving the oven a uniform shape.

This oven cabinet is placed on the stand that supports the enclosure by means of locking clips 40 that take up position in suitable sockets formed in said stand. In order to limit heat transfer between the enclosure and the cabinet, the zones of contact between the enclosure and the stand are located as far away as possible from the clip-fastening zones. In addition, the sheet metal of the enclosure is cut away in the vicinity of its points of contact with the stand in order to minimize heat bridges between the enclosure and the stand.

In a variant embodiment, the stand has significant vertical walls, thereby further restricting heat transfer from the stand to the cabinet.

In order to further restrict the temperature rise of the cabinet, a heat screen 20 is disposed between the top 4c of the enclosure and the top 18c of the cabinet. This heat screen covers the entire surface of the top of the cooking enclosure and even extends beyond the wall 4b over the control portion of the oven. The heat screen 20 also possesses folded portions at the ends of its four edges, which portions extend downwards. The side portions 22a and 22b and the rear portion 22d, visible in FIGS. 2 and 3, are quite long and extend as far as the cabinet, taking up positions against retaining lugs 34. This enables them to protect the respective walls 18a, 18b, and 18d of the cabinet effectively by closing off the hottest space near the high portion of the enclosure, while also ensuring that the screen is properly positioned relative to the cabinet.

The front portion 22c is shorter and is positioned against the front rim 14, thereby ensuring that there is a predetermined distance between the top 4c of the enclosure and the heat screen 20 and reinforcing the partitioning of the space between the reflector and the enclosure.

In addition, a cylindrical spacer 24 is positioned in an opening 26 in the heat screen, substantially in the middle thereof. This spacer 24 has a step in its diameter so as to present a bearing surface enabling it to be positioned on said heat screen.

The spacer 24 thus extends on either side of the heat screen 20 so as to come into contact specifically with the top 18c of the cabinet. Clearance is left relative to the top 4c of the enclosure, essentially to avoid creating a thermal bridge with said surface which is raised to high temperature when the oven is in operation. In addition, this clearance serves to accommodate tolerance differences between the various parts, thus ensuring that the cabinet can be put into place without deforming said cabinet and/or the heat screen.

In addition, the spacer serves as mechanical reinforcement for the top 18c of the cabinet, and prevents a heavy object placed on said top giving rise to significant deformation of the cabinet.

The spacer is advantageously made of a material that presents low thermal conductivity. Materials such as plastics satisfy this requirement, presenting thermal conductivity of about 0.2 Wm⁻¹K⁻¹ to 0.3 Wm⁻¹K⁻¹. Nevertheless, the plastics material must be capable of withstanding high temperatures, since it is possible it might come into contact with the top of the enclosure.

The reduction in heat exchange and the disposition of the heat screen enable the temperature of the cabinet to be reduced considerably, so much so that plastics materials such as polypropylene (PP) can be used. It is then possible to make the cabinet by injection-molding, with the resulting one-piece cabinet making the oven easier to assemble.

Nevertheless, since such materials have low melting points, the hottest points need to be protected when in contact with metal parts of the cooking enclosure or the heat screen. It is then preferable to use temperature-resistant studs of thermoplastic or thermosetting material that are compatible with such temperatures and that present low thermal conductivity, e.g. less than 1 Wm⁻¹K⁻¹. In the figure shown, the heat screen comes down far enough along the enclosure for there to be no need to use a temperature-resistant plastics material to implement the screen support lugs 34, and so the lugs also are made out of PP.

Advantageously, the oven cabinet includes a face plate 28 over the oven door. This face plate is made of metal and it is connected to the plastics cabinet via two insulating rods 30, 31.

Over the oven door, temperature can rise suddenly and reach high values when the door is left ajar or when its gasket is faulty, or because the gasket is missing. The extent to which the cabinet rises in temperature can then be limited by increasing the number of heat screens and by increasing their quality.

Nevertheless, it is more advantageous, economically speaking and without significantly lowering safety, particularly in terms of the risk of burns, to place a metal face plate in this location, which face plate therefore rises in temperature and serves to dissipate heat to the outside. It is then necessary for this face plate to be insulated from the plastics portions of the oven cabinet. The rods 30 and 31, e.g. made of PBT perform this thermal retarder function. They also provide a mechanical connection between the top portion of the plastics cabinet and the face plate which can be connected to the cooking enclosure.

The connections between the rods and the face plate, and the connections between the rods and the plastics cabinet are such that the number of contact points is restricted to the number needed for ensuring mechanical positioning without local creep of the material at the points of contact, thereby limiting heat transfer by conduction. Special care is taken to keep the points of contact between the face plate and the rods far away from the points of contact between the rods and the cabinet so as to minimize heat transfer from the face plate to the cover via the rods.

In addition, as can be seen clearly in FIG. 5, the face plate may bear on or under the rim 14 at the front face of the oven, by providing a setback 36 against which the door presses when in its closed position. As a result, heat escaping from the front face of the cooking enclosure (not shown) is inevitably collected by said face plate.

FIG. 4 shows clearly that the spacer serves to hold the heat screen 20 substantially halfway between the top 4c of the cooking enclosure and the top 18c of the cabinet.

In addition, and as can be seen clearly in the figures, the top 18c of the cabinet is domed, thereby providing said cabinet with better mechanical stability when its temperature rises to a certain extent.

Advantageously, the wall of the reflector and the walls of the enclosure facing the cabinet are treated so as to minimize emission by radiation, either by applying mechanical treatment and/or by applying a specific coating, as is known in this field. Care should then be taken that the coefficient of thermal emissivity is less than 0.3 for the faces in question and for temperatures lying in the range 150° C. to 300° C.

In operation, the heat generated by the heating resistance elements 32 is essentially reflected by the heat screen 20, or some of it is absorbed by the metal face plate 28, when present. Confining air above the top of the enclosure, in particular by restricting air admission to the leakage that results from assembly, thereby considerably limiting air movement, serves to reduce considerably the temperature of the oven cabinet 16.

Furthermore, since the cabinet is made of plastics material, having effusivity much less than that of steel, contact temperature for skin is considerably reduced, thereby further reducing the risk of burns.

The thermal effusivity of steel is about 14,000 Wm⁻²K⁻¹s^{1/2}. PP presents effusivity of about 400 Wm−²K⁻¹s^{1/2}, whereas the effusivity of the skin is close to 1800 Wm⁻²K⁻¹s^{1/2}.

It can be shown that under steady conditions, contact temperature is given by the expression:

$$T + \frac{( {T}_{1} {ɛ}_{1} + {T}_{2} {ɛ}_{2} )}{( {ɛ}_{1} + {ɛ}_{2} )}$$

where T₁ and ε₁ (and correspondingly T₂ and ε₂) are the temperature and the thermal effusivity of solid 1 (or solid 2).

To illustrate this formula, consider two plates, one made of steel and the other of a plastics material such as PP, the two plates both being raised to 85° C. Assuming that the temperature of the hand is about 37° C., calculations performed using the above formula lead to a contact temperature between the hand and the steel plate of close to 80° C., whereas the same contact temperature between the hand and the PP plate is hardly 46° C. Thus, touching a steel plate raised to 85° C. gives rise to a sensation of burning, whereas this sensation does not exist when the plate raised to the same temperature is made of a plastics material such as PP.

This shows the advantage of using a plastics material for the cabinet of an oven, and thus the importance of being able to reduce the temperature of the cabinet to such an extent that it is possible to use a low cost plastics material for making such a cabinet.

1. A domestic electric cooking oven (1) comprising an enclosure (2) defined by two side faces (4a, 4b), a top face (4c), a bottom face (4e), and a rear face (4d), main heater means (32) of the radiant type that emit essentially in the infrared arranged in the enclosure (2), said oven (1) having a cabinet (16) surrounding the major part of the enclosure (2) over its side faces (4a, 4b) and its top face (4c), the front face of the oven being fitted with a door and a control panel, the oven (1) being characterized in that it includes means limiting the heating of the oven cabinet (16).

2. A domestic electric cooking oven (1) according to claim 1, characterized in that the cabinet (16) also covers the major part of the rear face (4d) of the cooking enclosure (2).

3. A domestic electric cooking oven (1) according to claim 1, characterized in that the means limiting heating of the cabinet (16) of the oven (1) comprise confinement by partitioning the space between the top (4c) of the enclosure (2) from the top portion (18c) of the cabinet (16).

4. A domestic electric cooking oven (1) according to claim 1, characterized in that the cabinet (16) does not include any ventilation openings.

5. A domestic electric cooking oven (1) according to claim 3, characterized in that the top face (4c) of the enclosure includes a rim (14) contributing to confining the space between said top face (4c) of the enclosure from the cabinet (16).

6. A domestic electric cooking oven (1) according to claim 1, characterized in that a heat screen (20) is disposed in the confinement space between the top portion of the cabinet (18c) and the top (4c) of the enclosure (2).

7. A domestic electric cooking oven (1) according to the preceding claim 6, characterized in that the heat screen (20) covers at least the entire surface of the top (4c) of the enclosure (2).

8. A domestic electric cooking oven (1) according to claim 6, characterized in that the heat screen (20) has vertical walls (22a, 22b, 22c, 22d) sloping downwards and extending over the side faces (22a, 22b) and the rear face (22d) as far as the cabinet (16) of the oven.

9. A domestic electric cooking oven (1) according to claim 6, characterized in that a spacer (24) of material having low thermal conductivity is placed substantially in the middle of the heat screen (20) extending on either side of said screen, perpendicularly thereto, both to the vicinity of the top (4c) of the enclosure (2), and to the cabinet (16).

10. A domestic electric cooking oven (1) according to claim 1, characterized in that a metal face plate (28) is disposed substantially over the door, at least over the length of the cooking enclosure (2), said face plate (28) being connected to the cabinet (16) by an insulating rod (30).

11. A domestic electric cooking oven (1) according to claim 10, characterized in that the insulating rod (30) is made of a temperature-resistant plastics material such as PBT.

12. A domestic electric cooking oven (1) according to claim 1, characterized in that the cabinet (16) is made of a thermoplastic type plastics material, such as PP.

13. A domestic electric cooking oven (1) according to claim 1, characterized in that the metal face plate (28) includes fine openings.
